(19) United States
(12) Patent Application Publication
(10) Pub. No.: US 2006/0124055 A1
(43) Pub. Date: Jun. 15, 2006

(54) Mask-retaining device

(76) Inventors: Walter Franken, Eschweiler (DE); Gerhard Karl Strauch, Aachen (DE)

Correspondence Address: ST. ONGE STEWARD JOHNSTON & REENS, LLC, 986 BEDFORD STREET, STAMFORD, CT, 06905-5619, US

(21) Appl. No.: 11/286,170

(22) Filed: Nov. 23, 2005

Related U.S. Application Data
(63) Continuation of application No. PCT/EP04/50389, filed on Mar. 29, 2004.

(30) Foreign Application Priority Data
May 28, 2003 (DE) 10324202.3

(51) Int. Cl. B05C 11/11; B05C 13/00

(52) U.S. Cl. 118/503; 118/505

(57) ABSTRACT

The invention relates to a device for removably fixing a mask in the form of a rectangular frame, on the legs of which clamping means are provided for gripping the end of the mask. According to the invention, the clamping means comprise a plurality of individual spring elements which grip closely adjacent points on the mask edge. The individual spring elements which are assigned to one leg of the frame and are embodied as leaf springs that are interconnected in a comb-type manner can be moved from a fitting position in which the frame can be fitted with the mask into a clamping position by means of a common auxiliary clamping member.

### CROSS-REFERENCE TO RELATED APPLICATIONS

This application is a continuation of International Patent Application No. PCT/EP2004/050389 filed on Mar. 29, 2004, which designates the United States and claims priority of German Patent Application No. 10324202.3 filed on May 28, 2003.

### FIELD OF THE INVENTION

The invention relates to a device for releasably retaining a mask in the form of a rectangular frame, stressing means which act on the limbs of the frame at the edge of the mask being provided.

### BACKGROUND OF THE INVENTION

A device is known from WO 03/04719 A1 by means of which a circular mask is held. The device comprises a circular frame. If a radial stress is applied to the mask held by the frame, the sag in the center of the mask is reduced. In the case of masks used in the shadow process, it is important to minimize the sag to enable them to be aligned a short distance above the substrate. During alignment, the mask is lined up on the substrate using alignment marks. This is done optically. To avoid alignment errors, the alignment marks which have to be lined up need to be as close together as possible, on account of the limited depth of focus. Minimizing sag is also important for masks which are used below a substrate, so that when they are used as intended they are at a minimum distance from the substrate or a preliminary structuring on the substrate. Devices for securing masks are also already known from DE 195 33 402, U.S. Pat. No. 5,186,975 and U.S. Pat. No. 4,676,193.

The invention is based on the object of providing a device of the generic type for minimizing mask sag.

### SUMMARY OF THE INVENTION

The object is achieved by the invention described in the claims.

First and foremost, claim 1 provides that the stressing means have a multiplicity of individual spring elements, which engage on the mask edge at closely adjacent locations. The individual spring elements develop substantially the same stressing force, so that a virtually homogeneous tensile stress is applied to the edge of the mask. The deformation of the mask associated with the application of the stress is therefore equal at any point. The deformation to the frame limbs themselves, which is inevitable on account of the rectangular form of the frame, is compensated for as much as possible. The application of the stress to the individual spring elements is preferably effected by a common auxiliary stressing member. Each of the total of four frame limbs is preferably equipped with an auxiliary stressing member of this type. The individual spring elements may be leaf springs. These leaf springs can form the tines of a comb. The individual spring elements preferably act at windows in the edge of the mask. For this purpose, the edge of the mask can form a multiplicity of slot-like windows which follow one another. The slot length is in this case only insignificantly longer than the width of the leaf springs. The distance between the slots approximately corresponds to the width of a leaf spring. Furthermore, it is important for the ends of the leaf springs to extend approximately orthogonally with respect to the mask plane. The mask can in this case rest on a top side of the frame. The leaf springs may extend spaced apart along an outer side of the frame. The comb cross-piece, by which the individual leaf springs are connected to one another, can be pressed against an oblique flank of the frame limb by a stressing strip. For this purpose, the stressing strip forms a mating slope. The stiffness of the leaf springs is considerably less than the spring stiffness of the frame or of the mask. As a result, elastic deformation of the frame limbs on account of the stressing is compensated for. The stress which is applied to the mask by the leaf springs is less than the yield point of the material of the mask. However, the stress is sufficiently high for the mask, the size of which may be 370 mm×470 mm, preferably 600 mm×720 mm, to sag by no more than 0.2 mm, preferably less than 0.1 mm, in the center. The mask may consist of stainless steel or a molybdenum alloy. The mask has a multiplicity of regularly disposed openings, through which, when used as intended, material in the form of gases or aerosols can flow onto a pre-structured surface of a substrate, in particular of a parent glass. The device is used in particular for OVPD. In this process, organic layers are deposited on a glass substrate which has been pre-structured. The layers produce light-imitating fields (pixels), red-imitating and green-imitating fields are located adjacent to the blue-imitating fields. The field size is in the range between 20 and 200 μm. The individual fields may be separated from one another by means of spacers made from a polymer. The alignment prior to the coating of the mask used in the shadow process above the pre-structured substrate takes place at a minimum distance from the substrate. The alignment marks which are to be lined up are then at a minimum distance from one another. During the coating operation, the mask rests on the substrate. For this purpose, it is lowered after it has been aligned.

The mounting of the mask on the frame substantially takes place in two steps. With the stressing strip released, i.e. with the leaf springs unstressed, the metal mask is placed onto the top side of the frame. In the process, the ends of the leaf springs pass loosely through the associated windows in the edge of the mask. The comb cross-piece, which forms the fixed ends of the leaf springs, is in this case located in an open, obliquely running gap. If the stressing strip is displaced in the direction of the frame by application of a force, the leaf springs are bent. This is associated with the application of a stressing force, directed toward the mask plane, to the mask. The angle of inclination of the oblique flank, against which the comb cross-piece is pressed, is matched to the position of the windows in the mask or the stiffness of the leaf spring in such a way that the stressing force is sufficiently high but below the yield point of the material of the mask.

An exemplary embodiment of the invention is explained below with reference to the accompanying drawings, in which:

### BRIEF DESCRIPTION OF THE DRAWINGS

FIG. 1 shows, in plan view, a mask resting on a frame in the stressing position,

FIG. 2 shows a side view in the direction indicated by arrow 11 in FIG. 1,

FIG. 3 shows a section on line III-III in FIG. 1, with the position of a leaf spring in the unstressed state illustrated by dot-dashed lines,

FIG. 4 shows an illustration as in FIG. 3 prior to stressing but after loading,

FIG. 5 shows a detail corresponding to V in FIG. 1 taken from the surface of the mask, and

FIG. 6 shows a section on line VI-VI in FIG. 5.

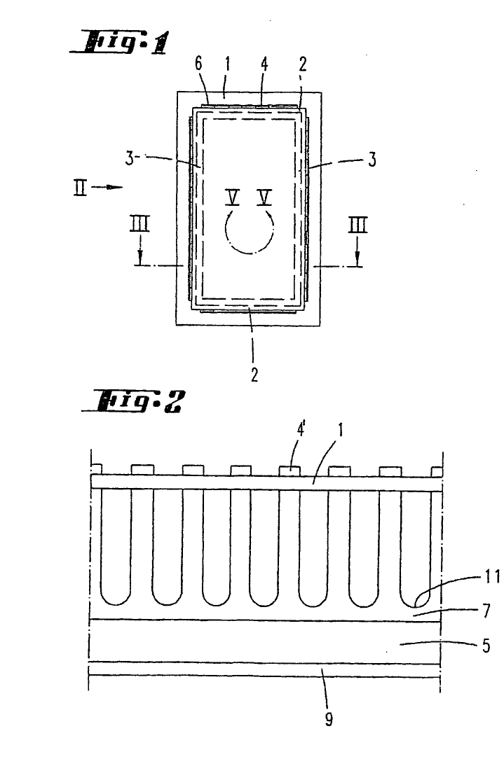

### DETAILED DESCRIPTION OF THE INVENTION

The device which is described in the exemplary embodiment is used to produce flat screens. In this process, individual light-imitating fields are applied to a substrate in a grid which corresponds to the pixel resolution of the screen. For this purpose, the substrate, which consists in particular of a parent glass, is pre-structured. The size of the substrate may be 370×470 mm2 or 600×720 mm2. First of all, a rectangular field grid 14 is applied to the substrate 15 by means of a photoresist or some other polymer. The rectangular grid comprises elongate fields, of which in each case three fields form a unit. Of these, in each case one field imitates red, blue or yellow.

The width of the fields D may be between 20 and 200 μm. Masks 1, which have masks openings 12 which, after position adjustment, are located in the plane of the mask above the fields, i.e. between the supports 14, are used to deposit a layer structure 13 within the fields. During the deposition of the light-imitating layers, in each case only a third of the fields are provided with a mask opening 12. Organic starting materials diffuse through this mask opening 12 in the form of aerosols or gases in order to condense on the layer structure 13.

It is important that the mask 1, which rests flat on the top side 2′ and consists of stainless steel or a molybdenum alloy, be uniformly stressed in its plane of extent. Only in this way is it possible to ensure minimal sag in the center of the mask 1 and for the distortion produced by application of the surface stressing to be homogeneous, so that it can be taken into account in the mask construction.

The edge of the mask is perforated. It has windows 6 positioned one after the other in a row. The length of the individual windows 6 in this case substantially corresponds to the spacing between them. In terms of size, the windows are approximately 10 to 20 mm from one another.

The outer sides 2″ of the frame limbs 2, 3 form oblique flanks 8 located at a distance from the top side 2′. Opposite the oblique flank 8 there is a mating slope 10 with the same inclination, which is associated with a stressing strip 5. The stressing strip 5 is located on a step 9 which adjoins the underside of the frame limb 2. A comb cross-piece 7, from which individual leaf springs 4 lead away in the form of tines, is located in this oblique slot formed by the inclined flank 8 and the mating slope 10. In the process, the ends 4′ of the leaf springs 4 engage through the windows 6 in the edge 1′ of the mask 1 in such a manner that the end portions 4′ of the leaf springs 4 extend approximately orthogonally with respect to the mask plane. In the stressed state, in which the comb cross-piece 7 bears flat against the oblique flank 8 or the mating slope 10, the leaf springs 4 engage in prestressed fashion in the windows 6.

An unstressed spring is illustrated by dot-dashed lines in FIG. 3. In that figure, a denotes the distance by which the leaf spring 4 is stressed.

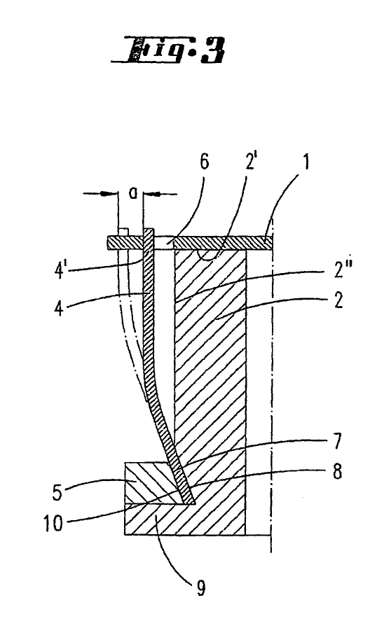

As can be seen from FIG. 2, the leaf springs 4 are evenly spaced apart from one another. The distance between them substantially corresponds to their width. The space between the individual leaf springs 4 has a rounded base 11. The leaf spring consists of steel or another suitable material.

Each of the total of four frame limbs 2, 3 may be provided with stressing means of this type. In this case, the stressing means which are associated with the narrow limbs 2 may have different spring stiffnesses than the stressing means which are associated with the longitudinal limbs 3.

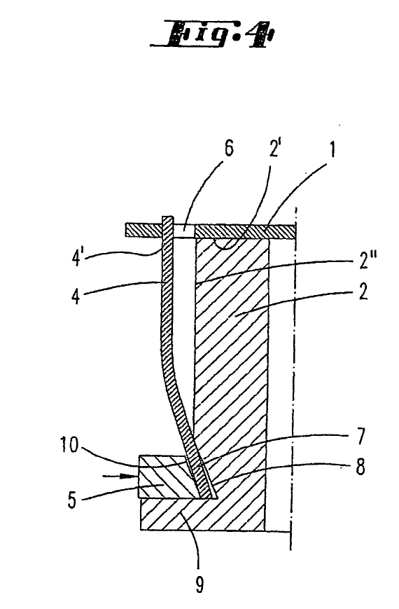

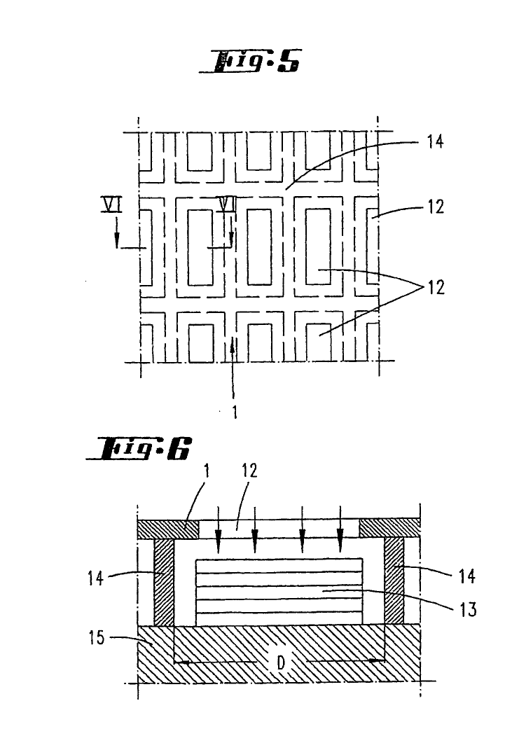

The frame is loaded in the released position of the leaf spring illustrated in FIG. 4. In this position, the stressing strip 5 has been displaced back in such a manner that the oblique gap between the oblique flank 8 and the mating slope 10 is wider than the thickness of the comb cross-piece 7. The comb cross-piece 7 is here located loosely within the oblique slot. If the mask 1 is then placed onto the top side 2′, 3′ of the frame limbs, the ends 4′ of the leaf springs 4 can be threaded loosely into the associated windows 6. Then, the stressing strips 5 are acted on in the direction of the arrow illustrated in FIG. 4. This can take place simultaneously at all the frame limbs 2, 3. The leaf spring 4 is bent in association with the displacement of the stressing strips 5 in the direction of the arrow. Their ends 4′ then exert a tension force on the mask 1 in the plane of extent of the mask. The tension force is virtually equal over the entire length of the frame limbs 2, 3, on account of the flat profile of the spring characteristic of the leaf spring 4. As an alternative to the oblique surface 8, it is also possible for the comb cross-piece 7 to be angled-off obliquely with respect to the leaf springs 4.

All features disclosed are (inherently) pertinent to the invention. The disclosure content of the associated/accompanying priority documents (copy of the prior application) is hereby incorporated in its entirety in the disclosure of the application, partly with a view to incorporating features of these documents in claims of the present application.

1. Apparatus for releasably retaining a mask in the form of a rectangular frame, stressing means which act on the limbs of the frame at the edge of the mask being provided, the stressing means having a multiplicity of individual spring elements, which engage in windows provided at neighboring locations on the mask edge, characterized in that the individual spring elements are leaf springs, the free ends of which, extending approximately orthogonally with respect to the mask plane, engage in the windows in the mask.

2. Apparatus according to claim 1, characterized in that the individual spring elements associated with a frame limb can be brought by a common auxiliary stressing member from a loading position, in which the frame can be loaded with the mask, into a stressing position.

3. Apparatus according to claim 1, characterized in that the leaf springs are connected to one another in the style of a comb.

4. Apparatus according to claim 1, characterized in that the individual spring elements engage in windows in the mask.

5. Apparatus according to claim 1, characterized in that the fixed ends, which are formed in particular by a comb cross-piece, of the leaf springs can be acted on by a stressing strip, which forms the auxiliary stressing member, against an oblique flank of the frame limb.

6. Apparatus according to claim 1, characterized in that the mask rests against the frame top side, and the oblique flank, at a distance therefrom, is associated with the frame outer side.

7. Apparatus according to claim 1, characterized in that the spring characteristic of the leaf spring is flatter in the region of its stressing position than the spring stiffness of the frame and/or of the mask.

8. Apparatus according to claim 1, characterized in that the stress which is applied to the mask in the stressing position of the individual spring elements is below the yield point of the material of the mask but sufficiently high for the mask, the surface area of which is greater than or equal to 370 mm×470 mm, preferably greater than or equal to 600 mm×720 mm, to sag by no more than 0.2 mm, preferably less than 0.1 mm, in the center.
